(19) United States
(12) Patent Application Publication
(10) Pub. No.: US 2004/0100390 A1
(43) Pub. Date: May 27, 2004

(54) Queue management system and method

(75) Inventors: Timothy W. Giraldin, Ladera Ranch, CA (US); Patrick W. Giraldin, Ladera Ranch, CA (US); Regan E. Kelly, Laguna Niguel, CA (US); Martin F. Crowley, Lake Forest, CA (US); Eric Couch, Trabuco Canyon, CA (US); Y-Tin Gross, Ladera Ranch, CA (US); Mark Woo, Laguna Niguel, CA (US)

Correspondence Address: DUCKOR SPRADLING METZGER, 401 WEST A STREET, SUITE 2400, SAN DIEGO, CA, 92101-7915, US

(73) Assignee: SafeTzone Technologies Corp.

(21) Appl. No.: 10/717,052

(22) Filed: Nov. 18, 2003

Related U.S. Application Data
(60) Provisional application No. 60/427,874, filed on Nov. 19, 2002.
(60) Provisional application No. 60/427,901, filed on Nov. 19, 2002.
(60) Provisional application No. 60/427,875, filed on Nov. 19, 2002.
(60) Provisional application No. 60/427,731, filed on Nov. 19, 2002.
(60) Provisional application No. 60/427,713, filed on Nov. 19, 2002.

(51) Int. Cl. H04Q 1/00

(52) U.S. Cl. 340/825.28

(57) ABSTRACT

The disclosed embodiments of the invention relate to a method and system of communication for a confined area of a facility. Personal identification information is received in at least one of a set of stations distributed throughout the confined area. Attraction reservation information is received relating to at least one attraction to request at least one reservation for a guest. The reservation information is stored.

### RELATED APPLICATION

The following non-provisional applications are related to the present invention and are hereby incorporated by reference in their entirety: U.S. patent application Ser. No. 09/992,872, titled “IDENTIFICATION TAG FOR REAL-TIME LOCATION OF PEOPLE,” filed Nov. 13, 2001, and U.S. patent application Ser. No. 09/992,668, filed Nov. 13, 2001 and titled “System for Real-Time Location of People in a Fixed Environment.”

This application claims priority to the following provisional applications and are hereby incorporated by reference in their entirety: U.S. Provisional Patent Application Serial No. 60/427,901, titled MESSAGE COMMUNICATION SYSTEM AND METHOD, filed Nov. 19, 2002, U.S. Provisional Patent Application Serial No. 60/427,874, titled QUEUE MANAGEMENT SYSTEM AND METHOD, filed Nov. 19, 2002, U.S. Provisional Patent Application Serial No. 60/427,875, titled ROUTE PLANNING SYSTEM AND METHOD, filed Nov. 19, 2002, U.S. U.S. Provisional Patent Application Serial No. 60/427,731, titled CASHLESS SPENDING SYSTEM AND METHOD, filed Nov. 19, 2002, and U.S. Provisional Patent Application Serial No. 60/427,713, titled DATA ANALYSIS SYSTEM AND METHOD, filed Nov. 19, 2002.

This application claims priority to the following non-provisional applications and are hereby incorporated by reference in their entirety: U.S. Non-provisional patent application, Ser. No. ______, titled MESSAGE COMMUNICATION SYSTEM AND METHOD, filed Nov. 18, 2003, U.S. Non-provisional patent application, Ser. No. ______, titled ROUTE PLANNING SYSTEM AND METHOD, filed Nov. 18, 2003, U.S. Non-provisional patent application, Ser. No. ______, titled CASHLESS SPENDING SYSTEM AND METHOD, filed Nov. 18, 2003, and U.S. Non-provisional patent application, Ser. No. ______, titled DATA ANALYSIS SYSTEM AND METHOD, filed Nov. 18, 2003.

### BACKGROUND OF THE INVENTION

1. Field of the Invention

The present invention relates in general to a queue management system and method. It more particularly relates to such a queue management system and method for use in various environments or confined areas of facilities, such as in an amusement park, a theme park, a large retail store, a casino, a ship, or the like.

2. Background Art

There is no admission that any background art described in this section legally constitutes prior art.

The management of queues of people waiting to participate at a public attraction can be difficult and sometimes unrewarding to the people waiting in the queue. This is particularly true in large attractions, such as amusement parks or other such facilities.

If the queue is long, there can be associated long waits before the people enter the attraction. In so doing, they may be unable to attend as many attractions as desired during the day, and may spend less time at other attractions of the facility, such as restaurants, gift shops and the like. Thus, there have been attempts to more efficiently provide entrance to attractions such as those found in amusement parks or theme parks, as well as others. For example, a guest may be permitted to buy a ticket for an attraction such as a ride for a certain time during the day. In so doing, the person must first go to the desired attraction and obtain a ticket or pass for a particular time, and then go to other such attractions where express passes are available.

Such a procedure oftentimes is time consuming on the part of the guest who must walk over to each desired attraction which may be physically spaced apart over a large area throughout the amusement park or theme park or other facility. Also, the person may find it difficult in coordinating the times at which to arrive at each transaction, since there may be a substantial delay between walking between each attraction in the park.

### BRIEF DESCRIPTION OF THE DRAWINGS

The following is a brief description of the drawings:

FIG. 1 is a diagrammatic view of a person locating system, which may be constructed according to an embodiment of the invention;

FIG. 2 is a flow chart diagram of a disclosed method of the invention;

FIG. 3 is a diagrammatic representation of a queue management method of using the system of FIG. 1;

FIG. 4 is a flow chart diagram of the method of queue management according to an embodiment of the invention; and

FIGS. 5-9 are various screen shot diagrams for the system of FIG. 1.

### DESCRIPTION OF CERTAIN EMBODIMENTS OF THE INVENTION

The disclosed embodiments of the invention relate to a method and system of communication for a confined area of a facility. Personal identification information is received in at least one of a set of stations distributed throughout the confined area. Attraction reservation information is received relating to at least one attraction to request at least one reservation for a guest. The reservation information is stored.

According to the disclosed embodiments of the present invention, a queue management system and method relate to providing stations throughout a restricted or defined area of a facility where queue management is desired to permit guests to reserve rides or other attractions throughout a given period of time such as a day.

According to another embodiment of the invention, the queue management system enables the stations to be used for locating missing guests such as children who may have strayed to another portion of the amusement park or other facility.

Person Locating System

Many patrons who visit large confined commercial facilities of a facility such as zoos, waterparks, theme parks, amusement parks, large retail stores, casinos, ships and others have at some point, experienced the feeling of temporarily losing another member of their group or family. It may be easy under some circumstances for an individual to become lost in a crowd, where the person only a short distance such as twenty feet away from the rest of the group and yet the group may not be able to find him or her.

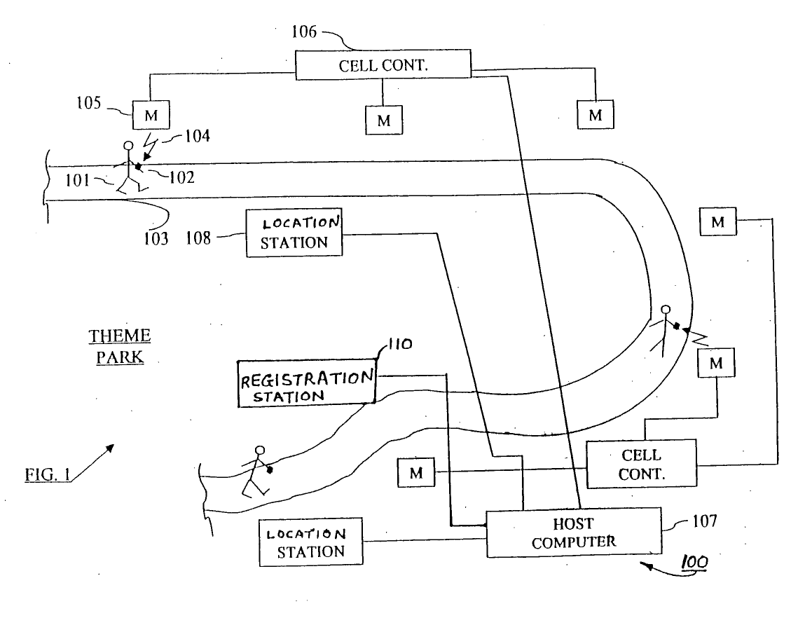

As shown in FIG. 1, an interactive person locating system 100 employs location stations such as station 108 distributed throughout the confined area to facilitate communication between and among member of the groups of patrons such as patron 101. A registration station 110 enables patrons to register their group so that members of the registered group can communicate privately with one another.

Group members or guests who interact with the system, at any location station, have the ability to visually discover the location of their group members on an electronic version of the facility or park map.

The members or guests are thus empowered to become a part of the solution in finding one another; to give them the ability to at least know where the rest of the party is when they cannot be found, or when they become separated by choice or by accident; to eliminate the feeling of panic that sweeps over a parent when they realize that a member of their group, such as their child, is not by their side or at the designated meeting place.

It helps for group members such as parents to know promptly that their children are still in the park, waiting in line for a ride or just running late.

Each member of a group obtains a waterproof transmitter in the form of a locator or personal identification (i.d.) tag 102 that is worn on the wrist or other part of the body or on the person's clothing. This locator continually communicates, via radio signal, with the child locating system 10 to update his or her location throughout the day. One example of such a tag is dislocated in the foregoing mentioned non-provisional patent application Ser. No. 09/992,872.

The location station 108 is a strategically placed interactive viewable workstation kiosk. These stations allow unaided guest access to the system with the locator 102. This gives the guest the ability to locate and view any locators in their group, to post messages on a private message board or to contact security. It also allows users to interact with any other system feature of module.

The registration station 110 is an interactive viewable workstation used by the park. The registration station 110 software module activates the locating software by enabling quick and easy registration of groups and individuals into the system 100 so that the system distinguishes between groups and between individuals within groups.

The confined area such as a park is divided into zones. These zones are the areas inside the property where guests need to be located. A zone can be as large or as small as needed. They can also be adjusted, expanded or minimized as necessary.

Guests are tracked as they pass along a path 103 through these zones via antennas such as an antenna 105 that are strategically placed throughout the property. These antennas, in return, send the tracking information to cell controllers such as cell controller 106, which conveys the information back to the central processing server or host computer 107 utilizing a wireless network. One example of such a system for the real-time location of people in a fixed environment is disclosed in the foregoing mentioned non-provisional patent application Ser. No. 09/992,668.

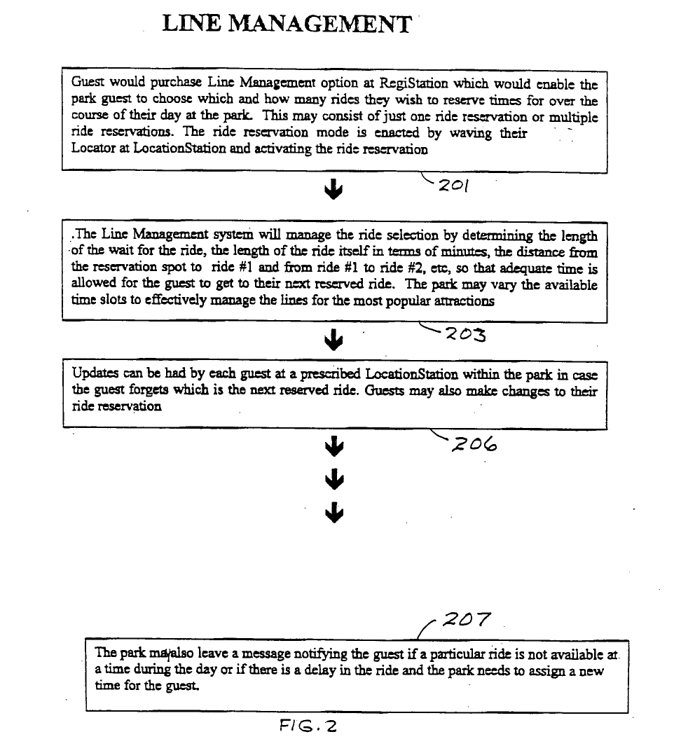

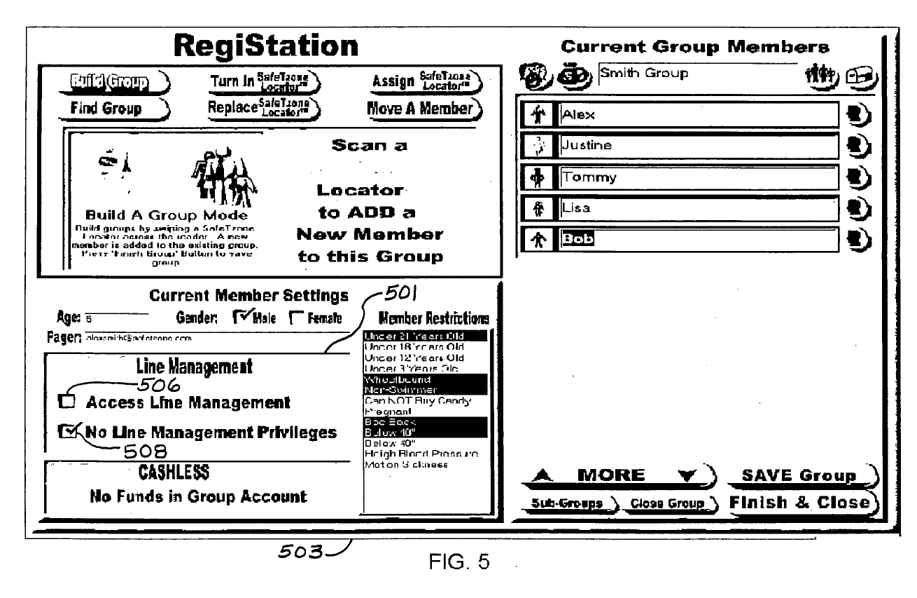

As shown in FIG. 2, the group member or guest must be registered as a user via a registration station such as the station 110 (FIG. 1) of the locating system 100 (FIG. 1) in order to use the queue or line management function. In this regard, as shown in FIG. 5, a line management box 501 on a registration station screen 503 enables a user to select a check box 506 to be selected if a line management is purchased by a guest or by a group member. If such an option is not purchased, then the “No Line Management Privileges” check box 508 is the default.

As indicated at box 201, group members or guests purchase a line management option at the registration station 110 (FIG. 1) which enables the facility guest to choose which and how many rides or other attractions they wish to reserve times for over the course of their day at the facility. This may consist of just one attraction reservation or multiple attraction reservations. The attraction reservation mode is enacted by a group member or guest waving or otherwise using their locator or identification tag such as tag 102 at a location station such as station 108 and activating the attraction reservation.

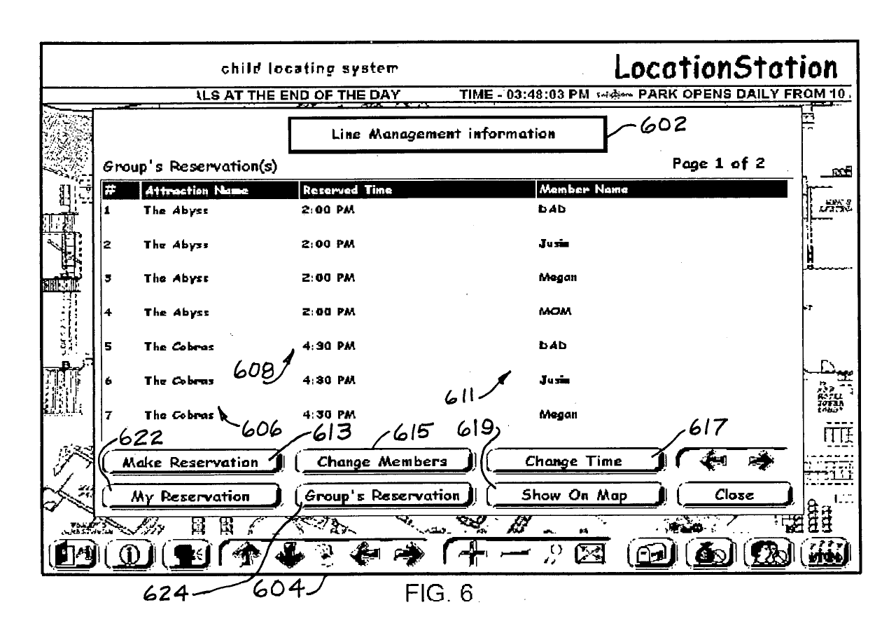

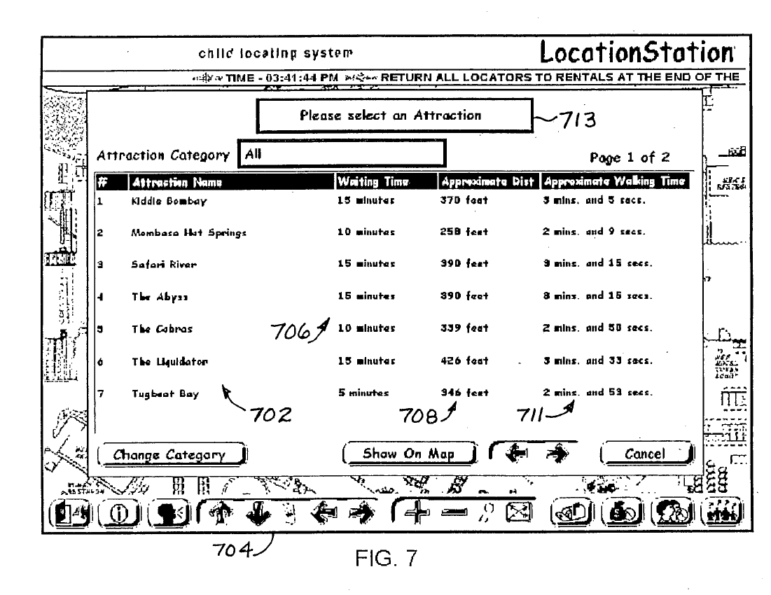

As shown in FIG. 6, a line management information message 602 is displayed on a screen 604 of a location station to display an attraction name list 606 and a corresponding reserved time list 608 as well as a corresponding member name list 611. This screen is displayed after a guest enters his or her personal identification information. Additional reservations can be made by activating a make reservation button 613. A button 615 initiates a program for changing members which have reservations. A change time button 617 is utilized to initiate a program for that function. The location of the reserved attractions may be displayed on a map by activating a button 619. A “My Reservations” button 622 is used to display only the reservations of one group member or guest. A button 624 is used to request a display of all reservations for a group such as the display illustrated in FIG. 6. When the button 613 is activated by a guest having line management privileges, a screen on a location station is displayed as shown in FIG. 7.

As shown in FIG. 7, when line management is selected, an attraction menu 702 is displayed on a location station screen 704. Also displayed are a waiting time list 706, an approximate distance list 708, and an approximate walking time list 711. A message 713 invites the user to select an attraction from the list 702.

As indicated at box 203 and as shown in FIG. 7, the queue or line management system manages the attraction selection by determining the length of time of the wait for the attraction such as a ride, the length of the time associated with the use of the attraction such as the time required for a ride in terms of minutes. Also determined is the distance from the reservation spot to the first attraction such as ride #1, and for example from ride #1 to ride #2, and so forth, so that adequate time is allowed for the guest to transition to their next reserved attraction. The facility may vary the available time slots for the starting and ending times for attractions, to effectively manage the queues or lines for the most popular attractions.

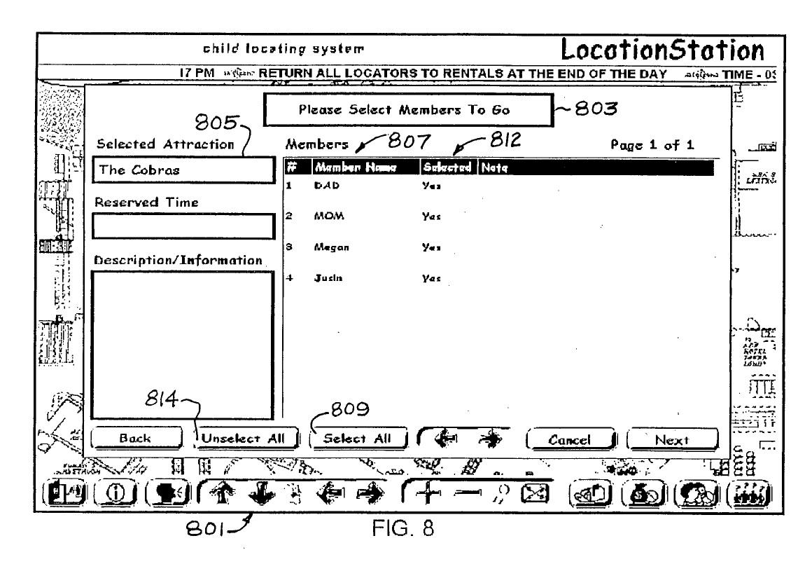

As shown in FIG. 8, after selecting attractions such as by a touch screen or other data entry process, a screen 801 is displayed and includes a message 803 requesting that group members be selected for the reserved attraction or attractions, which are displayed in a selected attraction box 805. A members list 807 displays the list of the members of the group. All the members can be selected by activating a select all button 809, which in turn causes a wood message “yes” to be displayed next to each name of a group member in a selected column 812. All of the members can be de-selected by activating an Unselect All button 814. The selections in the selected column 812 can be changed for each individual member by touch screen activation or other suitable data entry processes.

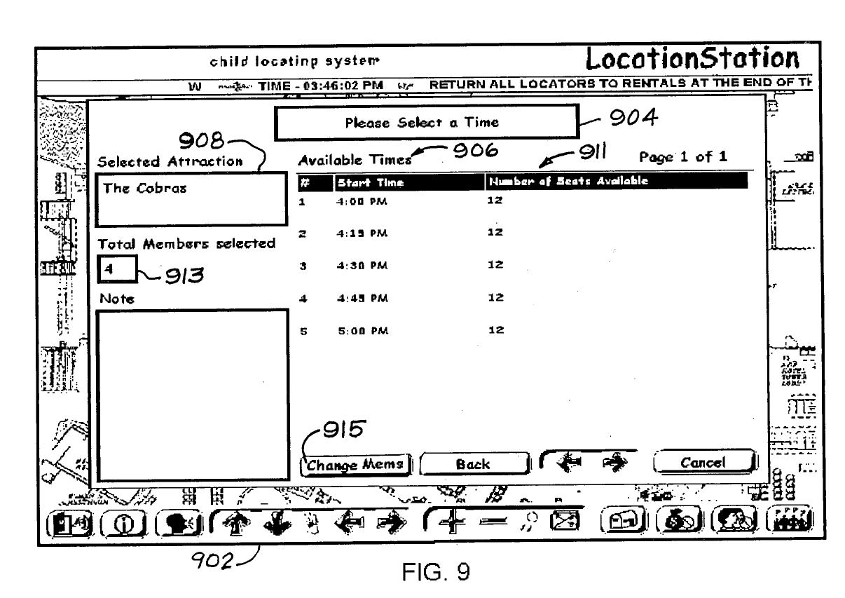

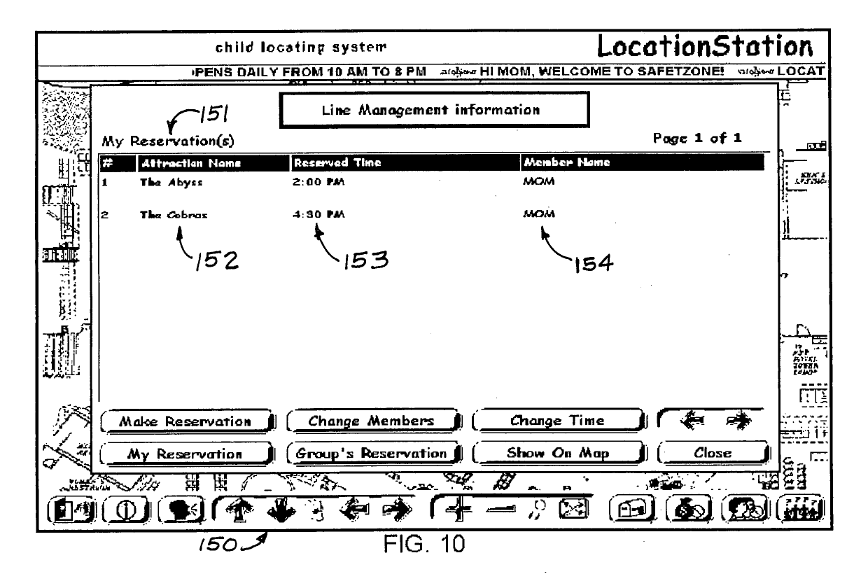

After selecting group members, a screen 902 is displayed as shown in FIG. 9. A message 904 is displayed to request the selection of the time of the selected attractions. An available time column 906 is displayed for the attraction displayed in a selected attraction box 908. The availability of the number of seats for the attraction is displayed in a list at 911. The selections can be made by a touch screen or other data entry process. A box 913 displays the total number of members selected for the attraction. The members can be changed by activating a button 9/5.

After the attraction times have been selected, as shown in FIG. 10, a screen 150 is displayed to provide line management information for the reservation selections. The screen 150 includes a “My Reservations” table 151, which includes an attraction name list 152, a reserved time list 153 and a member name list 154. It should be understood that the screen 150 is the format of a screen when a person activates a “My Reservation” button, as it displays on the reservation information for one group member and not the entire group.

As indicated at box 206, updates can be had by each group member or guest at a prescribed location station within the facility in case the guest forgets which is the next reserved attraction. Guests or group members may also make changes to their attraction reservation.

As indicated at box 207, the facility may also leave a message notifying the guest if a particular ride is not available at a time during the day or if there is a delay in the starting time of the attraction, and the facility desires to assign a new time or attraction for the guest.

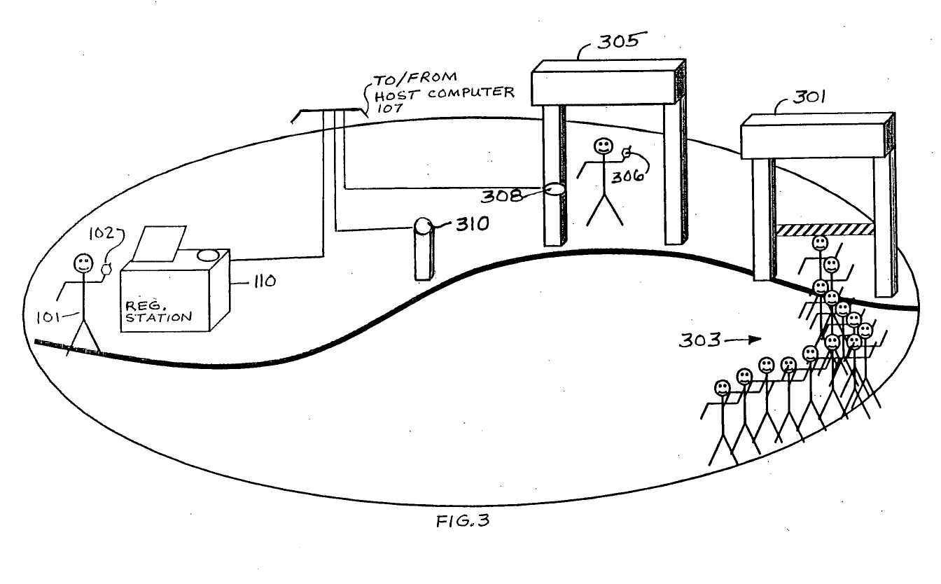

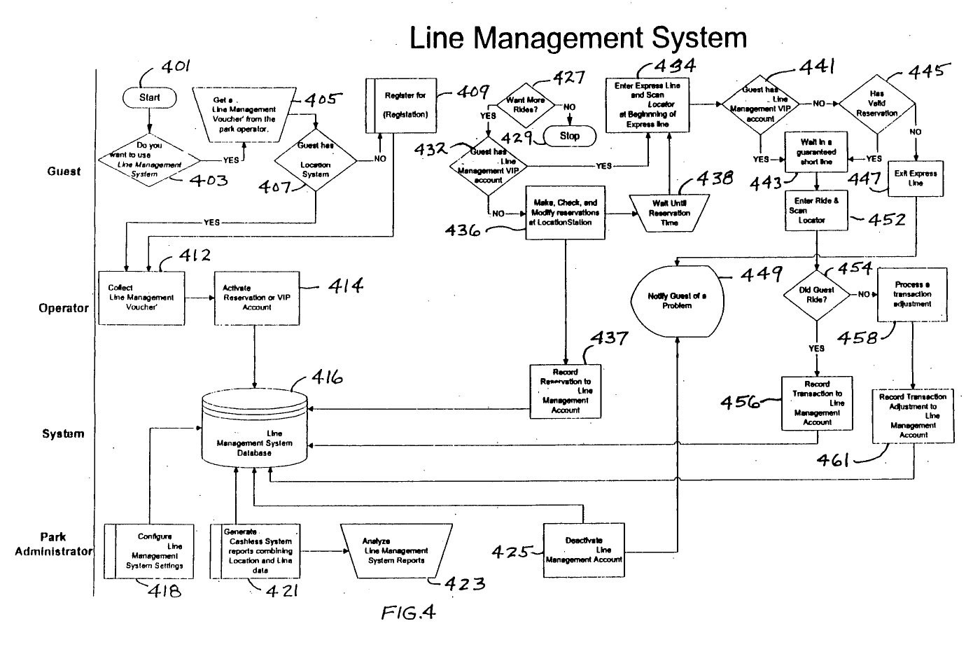

As shown in FIG. 3, the electronic line management solution of an embodiment of the invention is designed to reduce or eliminate wait-times usually associated with popular attractions. The line or queue management module is a software module, and is flexible and can be completely configurable to the expectations of the facility and level of guest service required. It is designed to embrace or replace existing line management systems in place today.

The queue online management/attraction reservation module can give guests the ability to reserve a place in line for most, if not all, major attractions at any location station to eliminate the wait-time usually associated with given attractions.

Depending on facility specifications, one individual may, for example, be able to make reservations for multiple people, for multiple attractions, all from one station such as a registration station or location station on the opposite side of the confined area of the facility, or other locations therein. Thus, the reservation does not have to be made at the location of the attraction itself.

Using the system of the disclosed embodiment of the invention, the facility may also allow a ‘line debit’ arrangement to be created, thus allowing guests to only use the line management feature once, twice or at a set or limited number of times, at a set number of attractions. This may prove to be useful when introducing a new major attraction at a facility.

The line management module may be configured to allow facility personnel to vary the available time slots for reservations to balance with expected or current line queue load. This allows facility personnel to effectively manage their line queues for their most popular attractions.

The line management module may be completely or at least partially integrated with the other modules available in the locating system 100 (FIG. 1). As indicated in FIG. 3, during guest registration at the registration station, guests choose to use the line management feature of the system. Guests can then reserve ride times using the location stations disposed throughout the confined area of the facility. If necessary, the group members or guests can also check their attraction times to ensure they do not miss their reservation.

Some features and benefits of the line management module include a flexible software platform allowing time algorithms to be adjusted according to specific needs. The system 100 may be a complete electronic solution for certain facilities, and allows guests to reserve times on pre-selected facility attractions to avoid long lines. It also may add an additional revenue source while providing a premier guest service, and may be seamlessly integrated into the person locating system.

This convenient line reservation method of the disclosed embodiments of this invention provides member groups such as families with the option to plan their day from one location. Many or most people may plan their activities around experiencing the major attractions. With this easy to use attraction reservation system, the most exciting and interesting attractions may not be missed.

As shown in FIG. 3, a main entrance gate 301 to an attraction can cause a long queue 303 of persons waiting to enter the attraction. However, by using the line management method of the disclosed embodiment of the invention, a person may be permitted to enter through another separate entrance gate 305 to the same attraction by merely waving or otherwise using his or her locator or identification tag 306 at a reader 308 to enter his or her personal identification information into the system 100. It should be understood that there can be another reader (not shown) at the beginning of the line whereby the person upon entering the line, utilizes his or her identification tag to register in the line. If the facility guarantees entrance at the special separate express entrance 305 within a defined period of time such as 15 minutes, the length of time in the queue can be monitored by the system 100. If a person has been waiting close to the guaranteed period of time, the facility operators can attempt to hurry the person through the line.

Referring now to FIG. 4, the line management method may be software controlled by software modules stored in the various stations, and the host computer 107 (FIG. 1). The method is started at box 401, and a decision is made at box 403 as to whether or not the guest desires to use the line management system. If he or she does so desire, then at box 405, the guest receives a line management voucher from the facility operator. At box 407, it is determined whether or not the group member or guest has already registered for the person location system 100 (FIG. 1). If not, then at box 409, the guest registers for the person location system. If the guest is already registered, then at box 412, the operator collects the line management voucher. At box 414, the operator activates the reservation or VIP account. This information is entered into the line management system database 416 of the host computer 107 (FIG. 1).

The facility administrator may configure the line management system settings as indicated at box 418 for the line management system database 416. Also, the facility administrator may generate a line management system report including a cash list system report combining location in line data as indicated at box 421. The facility administrator may analyze the line management system reports as indicated at box 423. Furthermore, the facility administrator can deactivate the line management account as indicated at box 425 by entering the deactivation signal to the line management system database 416.

As indicated at box 427, the group member or guest makes a decision as to whether or not additional attractions such as other rides are to be engaged. If not, then the line management system stops functioning as indicated at box 429. If additional attractions are desired, as indicated at box 432, it is determined whether or not the guest has line management VIP account. If he or she does have such an account, then as indicated at box 434, the guest enters an express line and scans his or her locator or identification tag at the beginning of the express line at the scanner 310 at the beginning of the queue. If the guest does not have the line management VIP account, the guest can make, check and modify reservations at a location station as indicated at box 436. Such entries are then recorded to the line management account as indicated at box 437 which causes the entry of the information into the line management system database 416.

Thereafter, the person merely waits until the reservation time as indicated at box 438 before entering the express line as indicated at box 434.

Once the person has scanned his or her locator or identification tag at the beginning of the express line, it is determined at box 441 whether the guest has line management VIP account status. If the answer is yes, at box 443, the guest is permitted to wait in the guaranteed short line. If the guest does not have the line management VIP account, then as indicated at box 445, it is determined whether or not the guest has a valid registration. If he or she does have such a valid registration, then as indicated at box 43, the guest can wait in the guaranteed short line. If the guest does not have a valid registration, then as indicated at box 447, the guest must exit the express line, and the guest is notified of a problem as indicated at box 449. In such a situation, the facility administrator may deactivate the line management account as indicated at boxes 425 and 449.

Once the person is permitted to wait in the guaranteed short line, the person enters the ride or other attraction and scans or otherwise uses his or her locator or identification tag as indicated at 452 to enter his or her personal identification information. Thereafter, it is determined at box 454 whether or not the guest did receive the ride or otherwise enter the attraction. If so, then as indicated at box 456, the transaction is recorded to the line management account in the line management system database 416. If the guest did not receive the ride or otherwise enter the attraction, then as indicated at box 458, a transaction adjustment is processed, and a transaction record adjustment is made to the line management account of the guest as indicated at 461.

While particular embodiments of the present invention have been disclosed, it is to be understood that various different modifications and combinations are possible and are contemplated within the true spirit and scope of the embodiments of the invention as disclosed and claimed herein. There is no intention, therefore, of limitations to the exact disclosure or abstract herein presented.

What is claimed is:

1. A method of communication for a confined area of a facility, comprising:
receiving personal identification information of a guest into at least one of a set of stations distributed throughout the confined area;
receiving attraction reservation information relating to at least one attraction to request at leasst one reservation for the guest; and
storing said reservation information.

2. A method according to claim 1, further including receiving registration information relating to a member or a group of members.

3. A method according to claim 2, further including determining whether the guest is registered in response to the personal identification information.

4. A method according to claim 1, further including displaying the length of time for waiting for at least one attraction of the facility.

5. A method according to claim 1, further including displaying the length of time associated with the use of at least one attraction of the facility.

6. A method according to claim 1, further including displaying the distance to an attraction and the distance between attractions.

7. A method according to claim 1, further including varying the available attraction time slots for the starting and ending times for attractions.

8. A method according to claim 1, further including displaying attraction reservation information, and receiving information to change the attraction reservation information at one or more of the stations.

9. A method according to claim 1, further including creating a message that an attraction is no longer available and assigning another attraction or starting time.

10. A method according to claim 1, further including permitting reservation information to be received only a set number of times for a certain number of attractions.

11. A method according to claim 1, further including receiving the personal identification information at a separate entrance to the reserved attraction.

12. A method according to claim 2, further including monitoring the length of time the guest waits in a queue for a reserved attraction.

13. A method according to claim 2, further including receiving personal identification information at the end of a queue, and determining whether the person entering the information is registered.

14. A method according to claim 13, further including receiving personal identification information at the beginning of the queue, and determining whether a person should be admitted to the attraction.

15. A method according to claim 1, further including generating line management system reports, said reports including a line management account for a given guest or group member.

16. A method according to claim 1, further including monitoring whether the guest attends the reserved attraction.

17. A software system of communication for a confined area of a facility, comprising:
a module for receiving personal identification information of a guest into at least one of a set of stations distributed throughout the confined area;
a module for receiving attraction reservation information relating to at least one attraction to request at leasst one reservation for the guest; and
a module for storing said reservation information.

18. A software system according to claim 17, further including a module for receiving registration information relating to a member or a group of members.

19. A software system according to claim 18, further including a module for determining whether the guest is registered in response to the personal identification information.

20. A software system according to claim 17, further including a module for displaying the length of time for waiting for at least one attraction of the facility.

21. A software system according to claim 17, further including a module for displaying the length of time associated with the use of at least one attraction of the facility.

22. A software system according to claim 17, further including a module for displaying the distance to an attraction and the distance between attractions.

23. A software system according to claim 17, further including a module for varying the available attraction time slots for the starting and ending times for attractions.

24. A software system according to claim 17, further including a module for displaying attraction reservation information, and receiving information to change the attraction reservation information at one or more of the stations.

25. A software system according to claim 17, further including a module for creating a message that an attraction is no longer available and assigning another attraction or starting time.

26. A software system according to claim 17, further including a module for permitting reservation information to be received only a set number of times for a certain number of attractions.

27. A software system according to claim 17, further including a module for receiving the personal identification information at a separate entrance to the reserved attraction.

28. A software system according to claim 18, further including a module for monitoring the length of time the guest waits in a queue for a reserved attraction.

29. A software system according to claim 28, further including a module for receiving personal identification information at the end of a queue, and a module for determining whether the person entering the information is registered.

30. A software system according to claim 29, further including a module for receiving personal identification information at the beginning of the queue, and determining whether a person should be admitted to the attraction.

31. A software system according to claim 17, further including a module for generating line management system reports, said reports including a line management account for a given guest or group member.

32. A software system according to claim 17, further including a module for monitoring whether the guest attends the reserved attraction.

33. A system of communication for a confined area of a facility, comprising:
means for receiving personal identification information of a guest into at least one of a set of stations distributed throughout the confined area;
means for receiving attraction reservation information relating to at least one attraction to request at leasst one reservation for the guest; and
means for storing said reservation information.

34. A system according to claim 33, further including means for receiving registration information relating to a member or a group of members.

35. A system according to claim 34, further including means for determining whether the guest is registered in response to the personal identification information.

36. A system according to claim 33, further including means for displaying the length of time for waiting for at least one attraction of the facility.

37. A system according to claim 33, further including means for displaying the length of time associated with the use of at least one attraction of the facility.

38. A system according to claim 33, further including means for displaying the distance to an attraction and the distance between attractions.

39. A system according to claim 33, further including means for varying the available attraction time slots for the starting and ending times for attractions.

40. A system according to claim 33, further including means for displaying attraction reservation information, and receiving information to change the attraction reservation information at one or more of the stations.

41. A system according to claim 33, further including means for creating a message that an attraction is no longer available and assigning another attraction or starting time.

42. A system according to claim 33, further including means for permitting reservation information to be received only a set number of times for a certain number of attractions.

43. A system according to claim 33, further including means for receiving the personal identification information at a separate entrance to the reserved attraction.

44. A system according to claim 34, further including means for monitoring the length of time the guest waits in a queue for a reserved attraction.

45. A system according to claim 44, further including means for receiving personal identification information at the end of a queue, and means for determining whether the person entering the information is registered.

46. A system according to claim 45, further including means for receiving personal identification information at the beginning of the queue, and determining whether a person should be admitted to the attraction.

47. A system according to claim 33, further including means for generating line management system reports, said reports including a line management account for a given guest or group member.

48. A system according to claim 33, further including means for monitoring whether the guest attends the reserved attraction.
